(19) United States
(12) Patent Application Publication
(10) Pub. No.: US 2008/0028023 A1
(43) Pub. Date: Jan. 31, 2008

(54) SHARING COMMENTARIES SYNCHRONIZED WITH VIDEO CONTENT

(75) Inventor: Jonathan W. Locke, Seattle, WA (US)

Correspondence Address: DARBY & DARBY P.C., P.O. BOX 770, Church Street Station, New York, NY, 10008-0770, US

(73) Assignee: Voicetribe LLC., Seattle, WA (US)

(21) Appl. No.: 11/775,109

(22) Filed: Jul. 9, 2007

Related U.S. Application Data
(60) Provisional application No. 60/820,373, filed on Jul. 26, 2006.

(51) Int. Cl. G06F 15/16

(52) U.S. Cl. 709/203

(57) ABSTRACT

Briefly stated, the present invention is directed to a system, apparatus, and method for creating audio tracks of commentary and for automatically synchronizing and playing of such commentaries with scenes in a movie, or other media content. The movie or other media content may reside on a DVD, or other computer-readable storage medium, or be streamed to the consumer's computing device. The consumer may record their own commentaries about the movie or other media content. The consumer may then provide their commentaries to a community of other commentaries. The commentaries may be organized into categories based on a variety of criteria, including the media, the contributor, a ranking of the commentary, or the like. A consumer may select various commentaries for playback during a movie or other media content. As the movie or other media content is played, automatic synchronization and playback of the selected commentaries may be performed.

### CROSS-REFERENCE

This utility patent application claims priority to U.S. Provisional Patent Application No. 60/820,373, filed on Jul. 26, 2006, entitled “Sharing Commentaries Synchronized with Video Content,” the benefit of which is claimed under 35 U.S.C. §119, and is further incorporated herein by reference.

### BACKGROUND OF THE INVENTION

The present invention relates to movie commentaries, and in particular, but not exclusively, to a system and method for enabling creation of tracks of commentaries and synchronizing the commentaries with scenes within the movie, or other recorded event.

Today, when a consumer purchases a movie on a digital versatile disk (DVD), or the like, the DVD will often include a director's commentary that may be played ‘over’ a version of the movie. Often, listening to such commentaries improves the consumer's appreciation for the movie. Such commentaries however, may be limited in that they may only provide the director's perspective of the movie. Therefore, it is with respect to these considerations and others that the present invention has been made.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 illustrates one embodiment of an environment in which the invention may operate;

FIG. 2 shows a functional block diagram of one embodiment of a client device configured to operate within the environment of FIG. 1;

FIG. 3 shows one embodiment of a server device that may be included in a system implementing the invention;

FIG. 4 illustrates a logical flow diagram generally showing one embodiment of a process for enabling sharing of commentaries synchronized with video content; and

FIG. 5 illustrates one embodiment of a screen shot of an application interface useable for playing synchronized commentaries, in accordance with the invention.

### DETAILED DESCRIPTION OF THE INVENTION

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

In this specification, the term “client” refers to a computer's general role as a requester of data or services, and the term “server” refers to a computer's general role as a provider of data or services. In general, it is possible that a computer can act as a client, requesting data or services in one transaction and act as a server, providing data or services in another transaction, thus changing its role from client to server or vice versa.

As used herein the terms ‘movie’ and ‘media content’ refer to any of a variety of digital content directed for play at a client device, including, but not limited to motion pictures, movies, videos, music videos, Pay-Per-View (PPV), Video-On-Demand (VoD), Content-On-Demand (CoD), interactive media, still images, PowerPoint files, slideshows, graphics, and so forth.

Briefly stated the present invention is directed to a system, apparatus, and method for creating a track of commentaries and for automatically synchronizing and playing of such commentaries with scenes in a movie, or other recorded media content portion. In one embodiment, a track of commentaries includes one or more selectable commentaries. These one or more selectable commentaries are sometimes referred to as comments. The movie or other media content may reside on a DVD, or other computer-readable storage medium. In one embodiment, the movie or other media content may be stored at a remote server from a consumer, and streamed to the consumer's computing device. In one embodiment, the consumer may pay a fee prior to being able to access the media content. In one embodiment, the consumer may also pay a fee for access to the commentaries. In another embodiment, the commentaries may be accessible for free based, in part, on indicating that the media content is accessible by the consumer.

Any event, additional commentaries may be locally recorded by the consumer. Thus, in one embodiment, the consumer may record their own commentaries about the movie or other media content. The consumer may then provide their commentaries to a community of other commentaries. The commentaries may be organized into categories based on a variety of criteria, including the media, the commentary contributor, a ranking of the commentary, or the like. For example, in one embodiment, various listeners of the commentaries may vote on a commentary based on a ranking system. In one embodiment, commentaries about the commentaries may also be provided.

In one embodiment, the commentaries may be stored on a remote server over a network. In another embodiment, the commentaries may be accessed through an application after payment of a fee, or, in another embodiment, for free. As the movie or other media content is played, automatic synchronization and playback of a selected commentary may be performed.

Illustrative Operating Environment

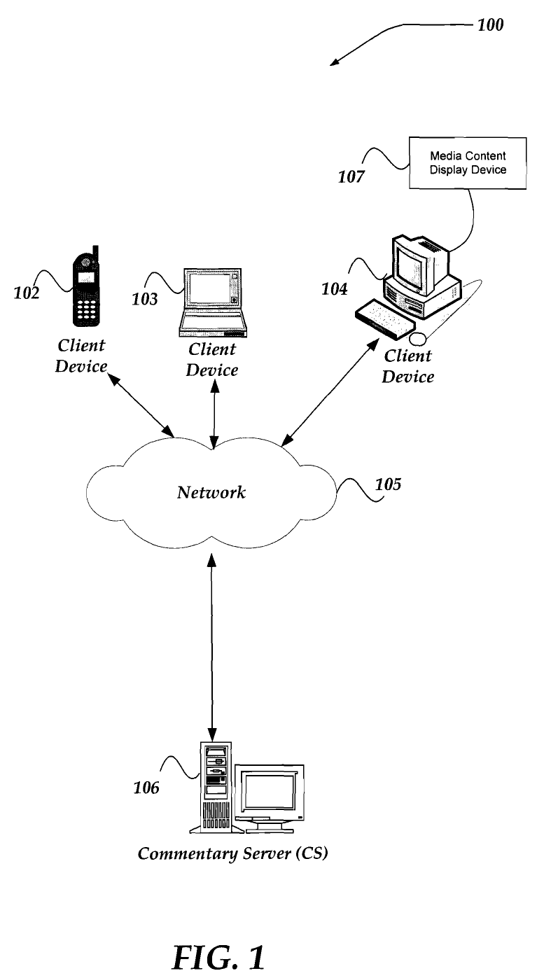

FIG. 1 illustrates one embodiment of an environment in which the invention may operate. However, not all of these components may be required to practice the invention, and variations in the arrangement and type of the components may be made without departing from the spirit or scope of the invention.

As shown in the figure, system 100 includes client devices 102-104, network 105, and Commentary Server (CS) 106. Network 105 enables communication between client devices 102-104, and CS 106.

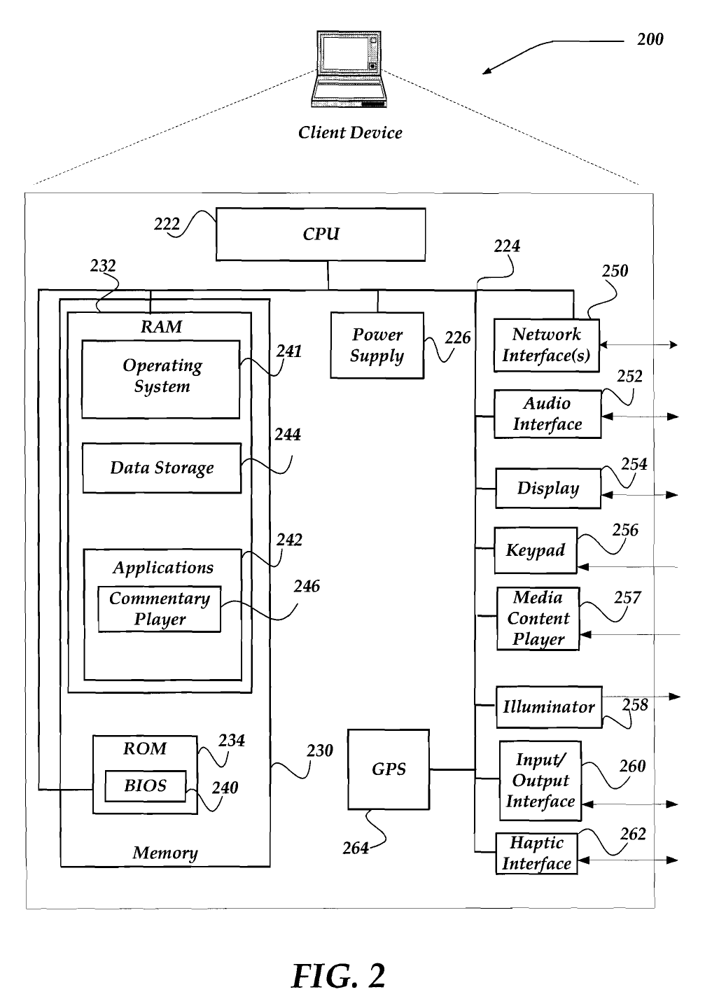

One embodiment of a client device is described in more detail below in conjunction with FIG. 2. Briefly, however, client devices 102-104 may include virtually any computing device capable of connecting to another computing device to send and receive information, including media content, commentary information, and other interactive information. The set of such devices may include devices that typically connect using a wired communications medium such as personal computers, multiprocessor systems, microprocessor-based or programmable consumer electronics, network PCs, and the like. The set of such devices may also include devices that typically connect using a wireless communications medium such as cell phones, smart phones, radio frequency (RF) devices, infrared (IR) devices, integrated devices combining one or more of the preceding devices, or virtually any mobile device, and the like. Similarly, client devices 102-104 may be any device that is capable of connecting using a wired or wireless communication medium such as a PDA, POCKET PC, wearable computer, and any other device that is equipped to communicate over a wired and/or wireless communication medium.

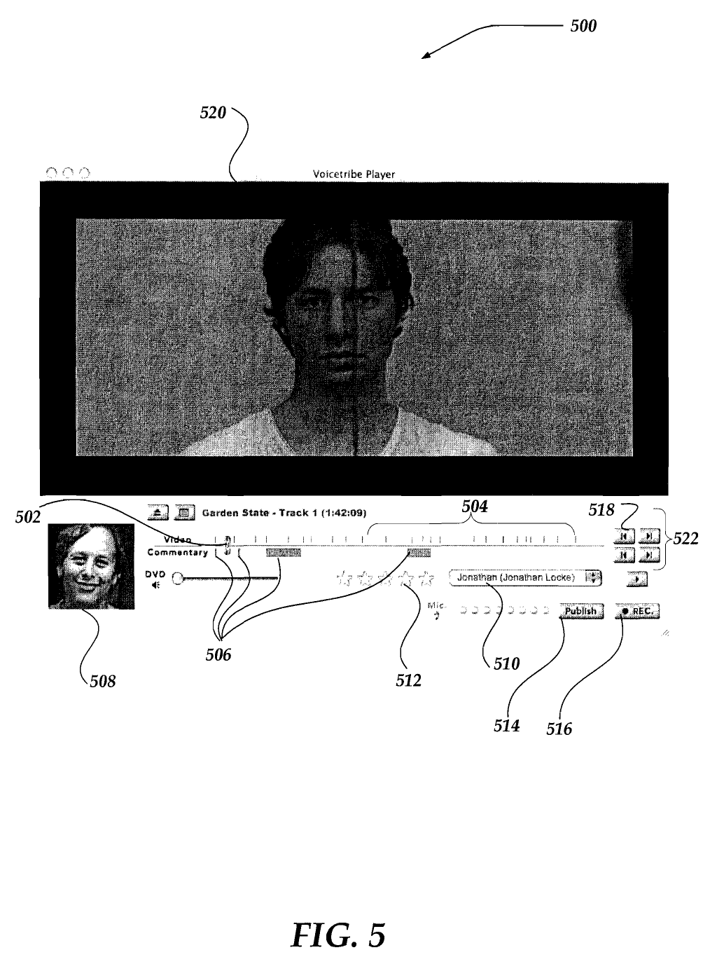

Moreover, client devices 102-104 may also include a commentary client player application, or the like, that is configured to enable an end-user to interact with and play various media content, such as a movie, music file, audio file, music video, PowerPoint presentation, or the like. Thus, the invention is not constrained to movies or other graphic oriented files, and other media content type of files may also be employed. The commentary player may be configured to interact with a commentary server program, or the like, and to provide an application interface such as described in more detail below in conjunction with FIG. 5.

Client devices 102-104 may receive and play media content using any of a variety of mechanisms. For example, in one embodiment, client devices 102-104 may be configured to receive media content over network 105. In one embodiment, the media content may be streamed over network 105, from another computing device, such as CS 106, or the like. In one embodiment, the media content may be streamed from a different computing device substantially similar to CS 106. Client devices 102-104 may also obtain the media content using a variety of other mechanisms, including receiving the media content through email, ftp, or the like. The media content may also be obtained for viewing using a variety of portable storage mediums, including but not limited to Digital Versatile Discs (DVDs), High Definition DVD (HD-DVD), Compact Discs (CDs), Video Compact Disc (VCD), Super VCD (SVCD), Super Audio CD (SACD), Dynamic Digital Sound (DDS) content media, Read/Write DVD, CD-Recordable (CD-R), Blu-Ray discs, memory storage devices, or the like.

Similarly, client devices 102-104 may also employ any of a variety of media content display devices (MCDD) 107 to enjoy such media content, including, but not limited to, a computer display system, an audio system, a jukebox, set top box (STB), a television, video display device, or the like.

Client devices 102-104 may also receive and/or provide commentaries associated with one or more media content. In one embodiment, client devices 102-104 may send and/or receive commentaries over network 105 with CS 106.

Network 105 is configured to couple client devices 102-104, and the like, with each other, and to CS 106. Network 105 is enabled to employ any form of computer readable media for communicating information from one electronic device to another. Also, network 105 can include the Internet in addition to local area networks (LANs), wide area networks (WANs), direct connections, such as through a universal serial bus (USB) port, other forms of computer-readable media, or any combination thereof. On an interconnected set of LANS, including those based on differing architectures and protocols, a router may act as a link between LANs, to enable messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art.

Network 105 may further employ a plurality of wireless access technologies including, but not limited to, 2nd (2G), 3rd (3G), 4th (4G) generation radio access for cellular systems, Wireless-LAN, Wireless Router (WR) mesh, and the like. Access technologies such as 2G, 3G, 4G, and future access networks may enable wide area coverage for mobile devices, such as client device 102 with various degrees of mobility. For example, network 105 may enable a radio connection through a radio network access such as Global System for Mobil communication (GSM), General Packet Radio Services (GPRS), Enhanced Data GSM Environment (EDGE), Wideband Code Division Multiple Access (WCDMA), Code Division Multiple Access 2000 (CDMA 2000) and the like.

Furthermore, remote computers and other related electronic devices could be remotely connected to either LANs or WANs via a modem and temporary telephone link. In essence, network 105 includes any communication method by which information may travel between client devices 102-104 and CS 106, and the like.

Additionally, network 105 may include communication media that typically embodies computer-readable instructions, data structures, program modules, or other data in a modulated data signal such as a carrier wave, data signal, or other transport mechanism and includes any information delivery media. The terms “modulated data signal,” and “carrier-wave signal” includes a signal that has one or more of its characteristics set or changed in such a manner as to encode information, instructions, data, and the like, in the signal. By way of example, communication media includes wired media such as, but not limited to, twisted pair, coaxial cable, fiber optics, wave guides, and other wired media and wireless media such as, but not limited to, acoustic, RF, infrared, and other wireless media.

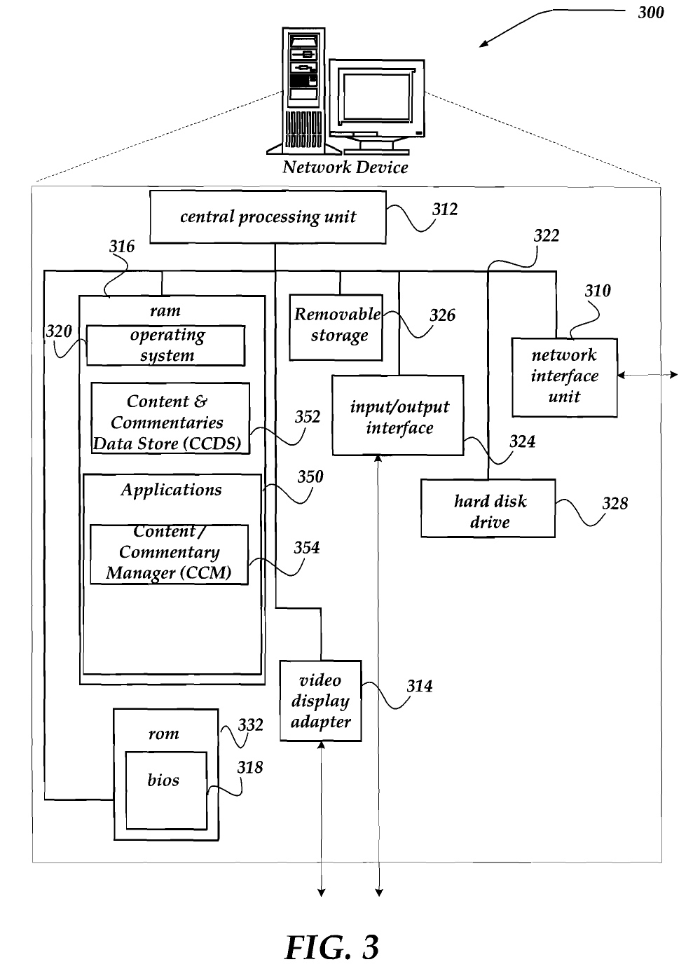

One embodiment, of CS 106 is described in more detail below in conjunction with FIG. 3. Briefly, however, CS 106 includes virtually any network device configured to include a commentary server program, and the like. As such, CS 106 may be implemented on a variety of computing devices including personal computers, desktop computers, multiprocessor systems, microprocessor-based devices, network PCs, servers, network appliances, and the like.

CS 106 may receive commentaries along with various other information for access by client devices 102-104. The other information may include, for example, comment timing information that is configured to synchronize the commentary with a location within media content. CS 106 may also receive and make available for access various voting information associated with a commentary. Such voting information may include a consumer's vote on a commentary. The vote may then be combined with other votes to provide a summary ranking or value of the commentary. The summary value information may be displayed at CS 106 using a variety of techniques, including stars, a numeric value, smiley faces, or the like.

CS 106 may also provide information that describes a provider of the commentary, including an avatar, a photograph, a name, or other identifier, and the like.

CS 106 may also organize the commentaries using a variety of basis, including, the media content with which the commentary is associated, a provider's identifier, a ranking based on user votes, or the like, a time, or media content provider identifier, or the like.

In one embodiment, CS 106 may enable a consumer to select a commentary for playback for free, or CS 106 may charge a fee. Moreover, CS 106 may enable a consumer to provide or post a commentary for free, or for a fee. In one embodiment, CS 106 may enable the user to provide a vote or other input, including a commentary about a commentary, for free, or for a fee. In one embodiment, CS 106 may provide a reward for a consumer that provides a defined number of commentaries. In another embodiment, CS 106 may provide a reward for a consumer that provides commentaries that are voted by others over a defined ranking. Such rewards may vary from a financial reward, such as a reduction in a fee, an increase in number of media content accessible at a reduced fee, a coupon for purchase of additional media content, or the like. The reward may also include postings of the consumer's information on a defined blog, or the like.

Illustrative Client Environment

FIG. 2 shows one embodiment of client device 200 that may be included in a system implementing the invention. Client device 200 may include many more or less components than those shown in FIG. 2. However, the components shown are sufficient to disclose an illustrative embodiment for practicing the invention. Client device 200 may represent, for example, at least one of client devices 102-104 of FIG. 1.

As shown in the figure, client device 200 includes a processing unit (CPU) 222 in communication with a mass memory 230 via a bus 224. Client device 200 also includes a power supply 226, one or more network interfaces 250, an audio interface 252, a display 254, a keypad 256, an illuminator 258, an input/output interface 260, an optional haptic interface 262, and an optional global positioning systems (GPS) receiver 264. Power supply 226 provides power to client device 200. A rechargeable or non-rechargeable battery may be used to provide power. The power may also be provided by an external power source, such as an AC adapter or a powered docking cradle that supplements and/or recharges a battery.

Client device 200 may optionally communicate with a base station (not shown), or directly with another computing device. Network interface 250 includes circuitry for coupling client device 200 to one or more networks, and is constructed for use with one or more communication protocols and technologies including, but not limited to, global system for mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, or any of a variety of other wireless communication protocols. Network interface 250 is sometimes known as a transceiver, transceiving device, or network interface card (NIC).

Audio interface 252 is arranged to produce and receive audio signals such as the sound of a human voice. For example, audio interface 252 may be coupled to a speaker and microphone (not shown) to enable telecommunication with others and/or generate an audio acknowledgement for some action. Display 254 may be a liquid crystal display (LCD), gas plasma, light emitting diode (LED), or any other type of display used with a computing device. Display 254 may also include a touch sensitive screen arranged to receive input from an object such as a stylus or a digit from a human hand.

Keypad 256 may comprise any input device arranged to receive input from a user. For example, keypad 256 may include a push button numeric dial, or a keyboard. Keypad 256 may also include command buttons that are associated with selecting and sending images. Illuminator 258 may provide a status indication and/or provide light. Illuminator 258 may remain active for specific periods of time or in response to events. For example, when illuminator 258 is active, it may backlight the buttons on keypad 256 and stay on while the client device is powered. Also, illuminator 258 may backlight these buttons in various patterns when particular actions are performed, such as dialing another client device. Illuminator 258 may also cause light sources positioned within a transparent or translucent case of the client device to illuminate in response to actions.

Client device 200 also comprises input/output interface 260 for communicating with external devices, such as a headset, or other input or output devices not shown in FIG. 2. Input/output interface 260 can utilize one or more communication technologies, such as USB, infrared, Bluetooth™, or the like. Optional haptic interface 262 is arranged to provide tactile feedback to a user of the client device. For example, the haptic interface may be employed to vibrate client device 200 in a particular way when another user of a computing device is calling.

Optional GPS transceiver 264 can determine the physical coordinates of client device 200 on the surface of the Earth, which typically outputs a location as latitude and longitude values. GPS transceiver 264 can also employ other geo-positioning mechanisms, including, but not limited to, triangulation, assisted GPS (AGPS), E-OTD, CI, SAI, ETA, BSS or the like, to further determine the physical location of client device 200 on the surface of the Earth. It is understood that under different conditions, GPS transceiver 264 can determine a physical location within millimeters for client device 200; and in other cases, the determined physical location may be less precise, such as within a meter or significantly greater distances. In one embodiment, however, mobile device may through other components, provide other information that may be employed to determine a physical location of the device, including for example, a MAC address, IP address, or the like.

Mass memory 230 includes a RAM 232, a ROM 234, and other storage means. Mass memory may also include a media content player 257 that is configured to receive media content. Media content player 257 may include, for example, a disk drive, a DVD player, CD player, VCD player, R/W DVD system, or virtually any other storage mechanism capable of receiving and enabling playing of media content. Mass memory 230 illustrates another example of computer storage media for storage of information such as computer readable instructions, data structures, program modules or other data. Mass memory 230 stores a basic input/output system (“BIOS”) 240 for controlling low-level operation of client device 200. The mass memory also stores an operating system 241 for controlling the operation of client device 200. It will be appreciated that this component may include a general purpose operating system such as a version of UNIX, or LINUX™, or a specialized client communication operating system such as Windows Mobile™, or the Symbian® operating system. The operating system may include, or interface with a Java virtual machine module that enables control of hardware components and/or operating system operations via Java application programs.

Memory 230 further includes one or more data storage 244, which can be utilized by client device 200 to store, among other things, applications 242 and/or other data. For example, data storage 244 may also be employed to store information that describes various capabilities of client device 200. The information may then be provided to another device based on any of a variety of events, including being sent as part of a header during a communication, sent upon request, or the like. Data storage 244 may also store information that uniquely identifies client device 200 including a phone number, a Mobile Identification Number (MIN), an electronic serial number (ESN), Mobile Station International ISDN Number (MSISDN), or other mobile device identifier. Moreover, data storage 244 may also be employed to store messages, an address book, phone list, task lists, or the like.

Applications 242 may include computer executable instructions which, when executed by client device 200, transmit, receive, and/or otherwise process messages (e.g., MMS, IM, EMS, email, and/or other messages), audio, video, and enable telecommunication with another user of another client device. Other examples of application programs include calendars, browsers, email clients, IM applications, contact managers, task managers, transcoders, database programs, word processing programs, security applications, spreadsheet programs, games, search programs, and so forth. One example of an application 242 shown in FIG. 2 is commentary player 246.

One embodiment of an interface to commentary player 246 is described in more detail below in conjunction with FIG. 5. Briefly, however, commentary player 246 is configured to enable synchronized recording and/or playback of audio commentaries. The commentaries, sometimes also called commentary tracks, may be posted, and/or retrieved from a network device over a network. Commentary player 246 may also enable a consumer to provide votes, commentaries, or the like for a commentary already posted on the remote network device.

In one embodiment, commentary player 246 may be obtained over a network, for a fee, or, in one embodiment, for free. In one embodiment, a link may be provided with a media content that enables a consumer to access and download commentary player 246 over the network. In another embodiment, when a consumer loads a DVD or the like, that may include media content, an applet, script, program, or the like, may be launched that automatically accesses commentary player 246. However, the invention is not constrained to these approaches, and any of a variety of other mechanisms may be used to provide commentary player 246 onto client device 200. In one embodiment, however, commentary player 246 may even be accessed over a network and played over the network, rather than downloaded onto client device 200.

In one embodiment, the commentary player 246 may operate in conjunction with another application, such as a media player, or the like, to enable synchronized playing of media content with one or more commentaries.

Commentaries may be synchronized with the media content using any of a variety of mechanisms. For example, in one embodiment, timing information may be employed to synchronize a commentary with media content. In one embodiment, the timing information may provide a time code, such as a value in hours, minutes, seconds, frames (e.g., HH:MM:SS:FF), or the like. In another embodiment, timing information may be in seconds, milliseconds, or the like. In one embodiment, the timing information represents time after a starting point of the media content. In another embodiment, such as where the media content is a PowerPoint presentation, or the like, the timing information may also include a page number, or the like. When the media content reaches the time code mark, an associated commentary may be played, in synch, with the media content.

When playing back from the middle of a commentary, synchronization may be achieved by seeking to a correct relative location within the commentary. For example, in one embodiment, of commentary data below, a first commentary runs from 3 seconds (00:00:03:00) to 11 seconds (00:00:11:00). However, the invention is not constrained to these values, and others may also be used. If playback of the commentary track at five seconds (00:00:05:00) is requested, playback of the audio resource for the first commentary may begin not at the start of that resource, but at 2 seconds (00:00:02:00), or the like, relative to the start of that artifact, in one embodiment.

commentary −1|1|Jonathan|Jonathan|Locke|−1.0|−1.0|Test
{

comment −1|00:00:03:00|00:00:11:00
audio
{

metadata 1|15081|GSM|gsm|1|50.0|33|8000.0|16|GSM0610|false

}
comment −1|00:06:12:00|00:06:37:00
audio
{

metadata 1|42570|GSM|gsm|1|50.0|33|8000.0|16|GSM0610|false

}

}

In one embodiment, the referenced commentaries may be downloaded by commentary player 246 from the network device and possibly cached, or otherwise saved to minimize future downloads. In one embodiment, however, such referenced commentaries may be restricted from being savable on client device 200. Thus, for example, in one embodiment, after the commentaries have been played for a predefined number of times, or after a predefined amount of time has elapsed, the downloaded commentaries might be made inaccessible, until the consumer re-downs them from the network device. In another embodiment, the downloaded commentaries might become degraded during playback, further encouraging a consumer to repurchase or update the downloaded commentaries.

Although identifiers for commentaries may be created by the commentary player 246, or the network device, one embodiment to uniquely identify commentaries is to use some encoding of the start and end time-codes as a unique identifier of the audio resource. For example, in one embodiment, commentary player 246 or the network device could post and/or store the first commentary above using, for example, the identifier “00000300000001100,” or the like. However, the invention is not limited to such identifiers, and virtually any other identifier may be employed, including for example, one generated from a random value, one generated at least in part based on an identifier of the commentator with another random value, date time stamp, or the like.

Illustrative Server Environment

FIG. 3 shows one embodiment of a network device, according to one embodiment of the invention. Network device 300 may include many more components than those shown. The components shown, however, are sufficient to disclose an illustrative embodiment for practicing the invention. Network device 300 may represent, for example, CS 106 of FIG. 1.

Network device 300 includes processing unit 312, video display adapter 314, and a mass memory, all in communication with each other via bus 322. The mass memory generally includes RAM 316, ROM 332, and one or more mass storage devices, such as hard disk drive 328, and removable storage 326, including a tape drive, optical drive, and/or floppy disk drive. The mass memory stores operating system 320 for controlling the operation of network device 300. Any general-purpose operating system may be employed. Basic input/output system (“BIOS”) 318 is also provided for controlling the low-level operation of network device 300. As illustrated in FIG. 3, network device 300 also can communicate with the Internet, or some other communications network, via network interface unit 310, which is constructed for use with various communication protocols including the TCP/IP protocol. Network interface unit 310 is sometimes known as a transceiver, transceiving device, or network interface card (NIC).

The mass memory as described above illustrates another type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The mass memory also stores program code and data. One or more applications 350 are loaded into mass memory and run on operating system 320. Examples of application programs may include transcoders, schedulers, calendars, database programs, word processing programs, HTTP programs, customizable user interface programs, IPSec applications, encryption programs, security programs, VPN programs, account management, and so forth. As shown, mass memory may include content & commentaries data store (CCDS) 352, and application content/commentary manager (CCM) 354.

CCDS 352 includes virtually any component that may be configured and arranged to receive, store, or otherwise manage media content, associated commentaries, and related information, including, for example, rankings, commentary contributor information, or the like. As such CCDS 352 may include databases, spreadsheets with links to media content, files, folders, application programs, scripts, or the like. Although illustrated within ram 316, however, the invention is not so limited. Thus, in one embodiment, CCDS 352 may also reside entirely, or in part, within a variety of other mass memory components within network device 300, including, but not limited to removable storage 326, hard disk drive 328, or the like.

CCM 354 is configured and arranged to manage requests for media content, requests for commentary client applications, and to manage associated commentaries, and related content and/or commentary information. In one embodiment CCM 354 may receive requests from a client device, such as client devices 102-104 of FIG. 1, for a commentary player application. CCM 354 may then provide the commentary player application to the requesting client device, for free, or for a fee over a network. In one embodiment, CCM 354 may also be configured to request information about the user of the requesting client device, including, a user name, or the like. In one embodiment, CCM 354 may establish an account useable by the user of the requesting client device.

CCM 354 may receive and/or provide commentaries in response to a request. The commentaries may be associated with various media content as described above. Moreover, CCM 354 may receive commentaries from one or more users, where the commentaries may be associated with various media content. CCM 354 may provide the received commentaries to CCDS 352, for storage and/or later access. CCM 354 may also receive votes, rankings, or the like, for a commentary, a commentary provider, or the like. CCM 354 may also store, and/or otherwise access such information from CCDS 352 upon request from a user. Moreover, CCM 354 may also be configured to manage awards, fees, and the like.

Generalized Operation

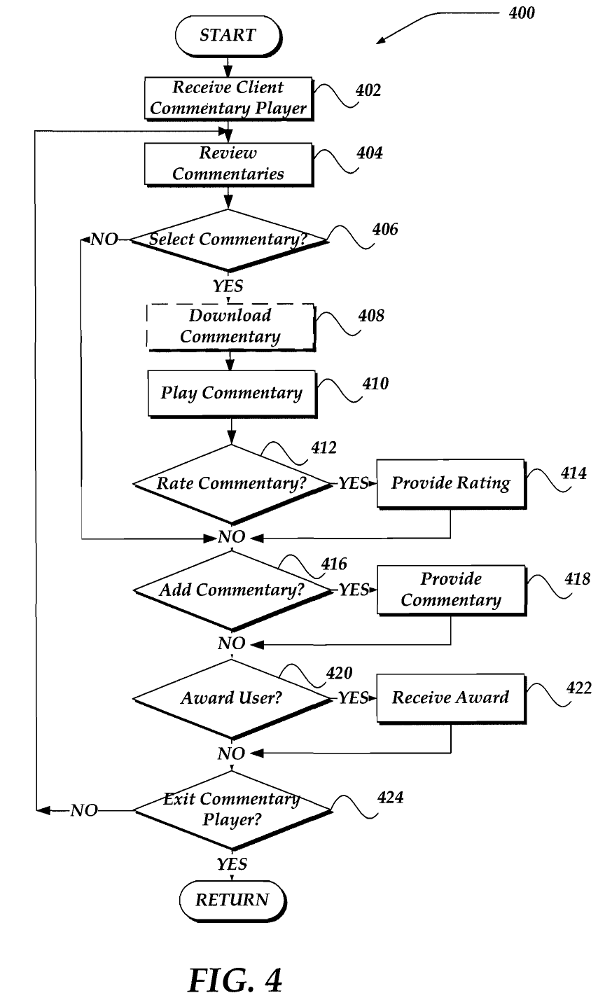

The operation of certain aspects of the invention will now be described with respect to FIG. 4. FIG. 4 illustrates a logical flow diagram generally showing one embodiment of a process for enabling sharing of commentaries synchronized with media content. Process 400 of FIG. 4 may be performed within a client device, such as client devices 102-104 of FIG. 1.

Process 400 begins, after a start block, at block 402, where a user of a client device selected to download or otherwise load onto their client device, a client commentary player application. In one embodiment, the user may receive the commentary player over a network. In one another embodiment, the user may also receive the commentary player from a portable storage medium, such as a DVD, HD-DVD, or any of a variety of other portable storage devices, including those described above. In one embodiment, the user might be requested to provide information about themself, including a name, alias, or the like. In one embodiment, the user might provide a fee for the commentary player. In any event, the commentary player may be accessed and installed onto the user's client device.

Processing flows next to block 404, where the user may select one or more commentaries that the user might want to play synchronized with media content. The user may employ an interface such as described below to review a commentary for play. In one embodiment, the interface is provided with the commentary player. In another embodiment, the user might employ a web page, or other interface that provides access to commentaries for play with the media content.

Process 400 flows next to decision block 406, where a determination is made whether the user has selected one or more commentaries for play synchronized with the media content. If so, processing flows to block 408; otherwise, processing branches to decision block 416. At block 408, the selected one or more commentaries are provided to the user for use with the media content. In one embodiment, the selected commentaries may be optionally downloaded from over a network. However, in another embodiment, the selected commentaries may already have been accessed. Thus, in one embodiment, the selected commentaries may already reside within the client device; therefore, they might not be downloaded again. That is, unless access to them has expired. In which instance, the user might be requested to pay a fee, download them again, download a key to enable access to them, or the like.

Processing continues to block 410 where the user may select to play the selected one or more commentaries synchronized with the media content. In one embodiment, the user may select to play one or more of the commentaries a plurality of times, or even a single time. Process 400 flows next to decision block 412, where a determination is made whether the user selects to rate one or more of the commentaries. If so, processing flows to block 414; otherwise, processing continues to decision block 416.

At block 414, the user may provide one or more ratings or votes to the selected one or more commentaries. Moreover, the user may modify existing ratings, add new ratings, delete previous ratings, or the like. When the user is satisfied, the user may then select to publish or otherwise share their ratings. In one embodiment, the user publishes the ratings by providing the ratings over the network to a remote network device. In one embodiment, the user may also provide information about themselves, including, but not limited, to a name, alias, an account identifier, an avatar, or the like. In one embodiment, the user might provide a fee. In another embodiment, the network device might record that the user is to receive an award for providing the one or more ratings. In any event, processing then branches back to decision block 416.

At decision block 416, a determination is made whether the user has selected to add a commentary synchronized with the media content. If so, the process branches to block 418; otherwise, processing continues to decision block 420.

At block 418, the user may select a position within the media content to which to associate a commentary. The user may record the commentary, edit the commentary, delete a previously recorded commentary, or the like. In one embodiment, the user may also provide a name, alias, account identifier, an avatar, or the like, to be associated with the commentary. In one embodiment, the user might provide a fee. In another embodiment, the network device might record that the user is to receive an award for providing the one or more commentaries. Processing then branches back to decision block 420.

At decision block 420 a determination is made whether the user is to be provided an award. As noted above, awards may be provided to the user for a variety of reasons, including, but not limited to providing commentaries, having a provided commentary rated above a defined threshold by other users, or the like. In any event, if the user is to receive an award, processing branches to block 422; otherwise, processing flows to decision block 424. At block 422, the user may receive an award that may include, but is not limited to a monetary award, such as a payment, a reduction in fees for media content, reduction in fees for accessing commentaries, providing commentaries, or the like. In one embodiment, the fees may include a coupon useable to make additional purchases elsewhere, or the like. In any event, processing branches back to decision block 424.

At decision block 424 a determination is made whether the user has selected to exit the commentary player. If so, processing returns to a calling process to perform other actions. Otherwise, processing may loop back to block 404 to enable the user to perform the actions above, including selecting different media content, commentaries, or the like.

It will be understood that each block of the flowchart illustration, and combinations of blocks in the flowchart illustration, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer implemented process such that the instructions, which execute on the processor to provide steps for implementing the actions specified in the flowchart block or blocks. The computer program instructions may also cause at least some of the operational steps shown in the blocks of the flowchart to be performed in parallel. Moreover, some of the steps may also be performed across more than one processor, such as might arise in a multi-processor computer system. In addition, one or more blocks or combinations of blocks in the flowchart illustration may also be performed concurrently with other blocks or combinations of blocks, or even in a different sequence than illustrated without departing from the scope or spirit of the invention.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems which perform the specified actions or steps, or combinations of special purpose hardware and computer instructions.

Illustrative Commentary Interface

FIG. 5 illustrates one embodiment of a screen shot of an application interface useable for playing synchronized commentaries. Interface 500 may include many more or less components than those shown. However, the components shown are sufficient to disclose an illustrative embodiment for practicing the invention.

As shown, interface 500 includes a display 520, and seekbar 522. Seekbar 522 may include slider bar 502, tick marks 504, commentary bars 506, and navigation buttons 518.

Seekbar 522 is configured to enable easy visualization and interaction for consumers engaged in synchronized recording and/or playback of a commentary that may hosted at a remote network device, such as CS 106 of FIG. 1, or otherwise provided by the network device. Seekbar 522 may be used to synchronize audio playback with virtually any media content, including non-video sources such as a slideshow, PowerPoint presentation, or the like.

As shown, as a consumer drags slider 502 along seekbar 522, a current playback position of the video and audio commentary are changed simultaneously. The position may also be changed by clicking a mouse, or by using the keyboard.

Tick marks 504 above a horizontal line within seekbar 522, provides one embodiment of indicating a location of various video chapters, scenes, or other portions, within the media content displayed within display 520. In one embodiment, tool tip windows may popup within display 520, or elsewhere within interface 500 to show a name of each chapter, scene, or other portion. In one embodiment, the popup window may be displayed when a mouse is moved over a chapter or scene tick mark.

Commentary bars 506 provide a visual indication of a location and duration of a commentary synchronized with the media content. In one embodiment, commentary bars 506 may also provide an indication of a state of download of the associated commentary. In one embodiment, prior to accessing the synchronized commentaries, a consumer may preview the locations of the commentaries at a similar interface's seekbar at the remote network device's website, or the like. Thus, in one embodiment, the consumer may preview commentaries prior to downloading and/or launching the commentary player.

Navigation buttons 518 are provided in one embodiment, including a set of navigation buttons for the media content, and another set for the commentaries. In one embodiment, one navigation button 518 may include set of navigation buttons, some buttons associated with the media content, and others associated with the commentaries. Thus, in one embodiment those navigation buttons 518 associated with the media content may move a play position forward a chapter, a scene, or other determined amount, while another navigation button 518 associated with the media content may move the play position backwards (rewind) a chapter, scene, or the like.

Similarly, the set of next and previous navigation buttons, such as those just below the next and previous media content buttons may be configured to move the play position forward and backwards one comment (as indicated by the comment blocks below the line), respectively.

Using seekbar 522 with the next/previous comment buttons 518, it is possible to quickly locate and navigate to commentaries in a set of commentaries. The ability to do this makes it possible to annotate small portions of lengthy media content with commentaries without having to record or play back a commentary of the same or similar length.

The seekbar 522 may also be associated with a blow-up or “zoom in” area to make viewing of long commentaries easier. The blow up area can appear in-line within the seekbar 522 as a magnification “bubble” or in a separate area of the user interface.

Keyboard keys may be used to navigate between comments or to perform editing operations such as deleting the currently playing commentary from a set of commentaries.

When playback of the media content is at a desired location, a consumer may select to record their own commentary (track) using the record icon 516. In one embodiment, while the media content continues to play, the consumer may record the commentary until re-selecting the record icon 516. In one embodiment, the media content may automatically pause, while the consumer records the commentary, and until the record icon 516 is re-selected. The consumer may then reposition slider 502 to listen to their commentary. The consumer may enter as many commentaries as may fit within the time of the media content. Moreover, the consumer may select to delete and/or re-record any of their commentaries. When the consumer is ready, the consumer may select to publish the one or more commentaries (tracks) over a network to a server using the publish icon 514. In one embodiment, the server, and/or the commentary player may enable the consumer to also provide an avatar, picture, or other graphic that may be desirable when their commentary is player. In one embodiment, the avatar, or other graphic may be displayed such as avatar 508 in FIG. 5. When another's commentary is played by the consumer, and that other commentary provider has so provided, their avatar or other picture may instead be displayed. Moreover, in one embodiment, the consumer may receive an award for providing a commentary, as an incentive to contribute and participate in the sharing of commentaries. Such awards may include having their name or other identifier posted on a website, receiving a coupon for discount purchases of other media content, or the like.

Interface 500 further enables the consumer to select various commentaries, even during playback of a media content using commentary selector 510. As shown in the figure, commentary selector 510 may display a currently selected commentary's name, such as a provider of the commentary. Moreover, using any of a variety of mechanisms, including a slider, a pull-down menu, or the like, commentary selector 510 may display one or more possible commentaries that may be selected for playback. In one embodiment, when a new commentary track is selected, seekbar 522 and commentary selector 510 will update by downloading the selected commentary track information over the network. In one embodiment, if the selected commentary was previously selected, or otherwise accessed by the client device, the commentary track may already be available on the client device. In one embodiment, the requested commentary track may be cached on the client device. The consumer may then employ the slider bar 502 or the next/previous comment buttons 518 to select a play position such as the start of a comment within the selected commentary track.

Also shown in FIG. 5, is one embodiment of a rating icon 512, which enables the consumer to rate a currently playing commentary. Moreover, rating icon 512 may display, in one embodiment, an aggregate of ratings that may be used to determine an order that commentaries may show up in the dropdown. They may also determine the contents of a “top commentaries” list on the web site. In one embodiment, the consumer may be requested to provide a fee to rate a commentary. However, in another embodiment, the consumer may be able to provide a rating for free. In one embodiment, the consumer may receive an award for providing a rating, as an incentive to contribute and participate in the sharing of commentaries.

In addition, a personal association and/or role of a consumer may be used in conjunction with various collaborative filtering algorithms to narrow the list of commentaries displayed in the commentary selector 510. Such information may also enable a more complex interface permitting hierarchical navigation of ordered, filtered commentary matches based on this information.

A server hosting commentary tracks may provide further opportunity to apply collaborative filtering techniques to the overall pool of commentary tracks available, which may be very large. These tracks may be filtered and/or sorted based on the ratings and/or personal affinities of other users to the user viewing the site. This might allow a consumer to navigate a very large pool of commentary tracks by viewing, for example: (a) what public personalities like (b) what people filling certain roles like (c) what public personalities who are similar to the consumer's favorite public personalities like (d) what the users' friends like (e) what other users with highly rated commentaries like (f) what other people with similar tastes like, or any of a variety of other criteria.

The above specification, examples, and data provide a complete description of the manufacture and use of the composition of the invention. Since many embodiments of the invention can be made without departing from the spirit and scope of the invention, the invention resides in the claims hereinafter appended.

What is claimed as new and desired to be protected by Letters Patent of the United States is:

1. A method for providing a commentary over a network, comprising:
playing a media content at a client device;
enabling recording of the commentary synchronized with at least one portion within the media content;
publishing the commentary over the network to a commentary server;
selecting at least one other commentary from a plurality of commentaries at the commentary server; and
enabling the at least one other selected commentary to be synchronized and played with media content.

2. The method of claim 1, further comprising:
providing a vote for the at least one other selected commentary over the network;
employing the vote to rank the at least one other selected commentary; and
providing the ranking of the at least one other selected commentary at the commentary server.

3. The method of claim 1, further comprising:
providing an award to a user of the client device based in part on the published commentary.

4. The method of claim 1, further comprising:
receiving at least one of a name, alias, or avatar associated with the published commentary; and
displaying with the published commentary the received at least one of the name, alias, or avatar.

5. The method of claim 1, wherein the plurality of commentaries is organized into categories based on at least one of a commentary contributor, or a ranking of the commentary.

6. The method of claim 1, wherein recording of the commentary employs a user interface that enables selection of at least one scene such that the recording is synchronized with the at least one scene.

7. The method of claim 1, wherein enabling the at least one other selected commentary to be synchronized and played with media content further comprises downloading at least one of the at least one other selected commentaries from over the network.

8. A network device to manage an interactive computer environment, comprising:
a transceiver to send and receive data over a network; and
a processor that is operative to perform actions, comprising:
providing a commentary player over the network for installation on a client device;
receiving a request for at least one commentary for play with media content; and
providing the requested at least one commentary to the client device for playing at the client device, wherein the at least one commentary is synchronized and played with at least a portion of the media content.

9. The network device of claim 8, wherein the processor is operative to perform actions, further comprising:
receiving a recording of another commentary that is synchronized with at least one portion of the media content; and
enabling another client device to access the recording of the other commentary, such that the other client device is enabled to play the other commentary synchronized with another copy of the media content.

10. The network device of claim 8, wherein the processor is operative to perform actions, further comprising:
determining an award for the client device, based in part on one of receiving a commentary from the client device, or receiving a rating on another commentary from the client device; and
providing the award to the client device.

11. The network device of claim 8, wherein the processor is operative to perform actions, further comprising:
receiving a vote associated with at least one commentary from the client device; and
employing the vote to modify a ranking of the at least one commentary among a plurality of commentaries.

12. The network device of claim 8, wherein the commentary player further comprises:
a commentary bar configured to provide a visual indication of at least one of a location, a duration, or an indication of a state of download, of the at least one commentary synchronized with the media content.

13. A processor readable storage medium that includes data and instructions, wherein when the data and instructions are executed within a computing device, the computing device performs actions for managing commentaries to media content, the actions comprising:
installing a commentary player within the computing device;
displaying with the commentary player at least one indicator associated with a commentary synchronized with a media content;
playing the media content and further playing the commentary synchronized with the playing of the media content;
enabling recording of another commentary synchronized with at least one portion within the media content; and
publishing the other commentary over the network to a commentary server.

14. The processor readable storage medium of claim 13, wherein the actions further comprising receiving an award.

15. The processor readable storage medium of claim 13, wherein the actions further comprising:
receiving a vote for the commentary; and
providing the vote for the commentary to the commentary server, wherein the vote is included with other votes to modify a ranking of the commentary within a plurality of other commentaries.

16. The processor readable storage medium of claim 13, wherein the published other commentary is available to another computing device to be playable at the other computing device synchronized with another copy of the media content.

17. A system for managing a commentary to media content over a network, comprising:
a server device that is configured to perform actions, including:
providing a commentary player over the network;
receiving a request for at least one commentary for play with media content; and
providing the requested at least one commentary over the network; and
a client device that is configured to install the commentary player and employ the commentary player, in part, to perform actions, including:
requesting the at least one commentary from the server device;
playing the media content and the at least one commentary synchronized with the playing of the media content;
enabling recording of another commentary synchronized with at least one portion within the media content; and
publishing the other commentary over the network to the server device.

18. The system of claim 17, wherein publishing the commentary is made available for access by another client device for use in playing synchronized with another copy of the media content.

19. The system of claim 17, wherein the commentary player further comprises at least one of the following:
a commentary bar configured to provide a visual indication of at least one of a location, a duration, or an indication of a state of download, of the at least one commentary synchronized with the media content; or
a rating icon that is configured to enable a display of an aggregate of ratings or to enable entry of a rating of the at least one commentary.

20. The system of claim 17, wherein the commentary player performs actions, further including:
enabling selection of the recorded other commentary synchronized with the at least one portion of the media content; and
enabling playing of the selected recorded other commentary synchronized with the media content.
